(19) United States
(12) Patent Application Publication
(10) Pub. No.: US 2006/0228495 A1
(43) Pub. Date: Oct. 12, 2006

(54) Method of manufacturing an exhaust gas sensor

(75) Inventors: Wesley Paul Lee, Anderson, SC (US); Michael Dale Burke, Woodruff, SC (US); John Everett Day, Greenville, SC (US); Jens Stefan Schneider, Gross Gerau (DE)

Correspondence Address: MICHAEL BEST & FRIEDRICH LLP, 100 EAST WISCONSIN AVENUE, MILWAUKEE, WI, 53202, US

(73) Assignee: Robert Bosch GmbH, Stuttgart (DE)

(21) Appl. No.: 11/104,325

(22) Filed: Apr. 12, 2005

(51) Int. Cl. B05D 3/00; B05D 5/12; B05D 5/00

(52) U.S. Cl. 427/561; 427/421.1; 427/58

(57) ABSTRACT

A method of manufacturing an exhaust gas sensor includes providing a sensor element having an open end, a closed end, and an inner surface defining a chamber between the open and closed ends. The method further includes inserting a nozzle into the chamber, supplying an electrode material to the nozzle, and without substantially any relative movement between the nozzle and the sensor element, atomizing the electrode material to form a mist of electrode material that substantially surrounds the tip of the nozzle and deposits onto the inner surface of the sensor element to form an inner electrode.

### BACKGROUND

The present invention relates to exhaust gas sensors.

Exhaust gas sensors are well known in the automotive industry for sensing the oxygen, carbon monoxide, or hydrocarbon content of the exhaust stream generated by internal combustion engines. Stoichiometric or “Nernst”-type oxygen sensors (a widely-used type of exhaust gas sensor) measure the difference between the partial pressure of oxygen found in the exhaust gas and oxygen found in the atmosphere. By determining the amount of oxygen in the exhaust gas, the oxygen sensor enables the engine control unit to adjust the air/fuel mixture and achieve optimal engine performance. Other types of exhaust gas sensors that operate based on different principles are also known and widely used in the automotive industry.

### SUMMARY

There are a number of conventional methods for applying electrode material to an inner surface of a generally cup-shaped sensor element. Many of these prior art methods use more of the expensive electrode material than is actually needed to create the inner electrode of the sensor element. The use of an excessive amount of electrode material adds to the cost of manufacturing the exhaust gas sensors. Additionally, some of the prior art application methods require both relative translation and rotation between the sensor element and the device that applies the electrode material. These methods are complex and require machinery and parts capable of achieving the required translational and rotational movements. It can also be difficult to control the thickness, size, and position of the electrode material using these techniques.

The invention provides an improved method of manufacturing exhaust gas sensors, and more specifically an improved method for applying electrode material to an inner surface of a sensor element to form at least part of the inner or reference electrode. With the method of the invention, the application of excessive amounts of electrode material is greatly reduced or eliminated, and the need for relative rotational and/or translational movement between the sensor element and the device applying the electrode material is eliminated. The method of the present invention results in a substantially uniform and well-controlled layer of electrode material on the inner surface of the sensor element.

In one embodiment, the invention provides a method of manufacturing an exhaust gas sensor. The method includes providing a sensor element having an open end, a closed end, and an inner surface defining a chamber between the open and closed ends. The method further includes atomizing an electrode material using an ultrasonic spraying device to deposit a layer of electrode material onto the inner surface of the sensor element.

In another embodiment, the invention provides a method of manufacturing an exhaust gas sensor. The method includes providing a sensor element having an open end, a closed end, and an inner surface defining a chamber between the open and closed ends, inserting a nozzle into the chamber, supplying an electrode material to the nozzle, and without substantially any relative rotation between the nozzle and the sensor element, atomizing the electrode material to deposit a layer of electrode material onto the inner surface of the sensor element substantially 360 degrees around the nozzle.

In yet another embodiment, the invention provides a method of manufacturing an exhaust gas sensor. The method includes providing a sensor element having an open end, a closed end, and an inner surface defining a chamber between the open and closed ends, inserting a nozzle into the chamber, supplying an electrode material to the nozzle, and without substantially any relative movement between the nozzle and the sensor element, atomizing the electrode material to form a mist of electrode material that substantially surrounds the tip of the nozzle and deposits onto the inner surface of the sensor element to form an inner electrode.

Other aspects of the invention will become apparent by consideration of the detailed description and accompanying drawings.

### BRIEF DESCRIPTION OF THE DRAWINGS

FIG. 1 is a section view of an exhaust gas sensor embodying the invention.

FIG. 2 is an enlarged section view of a sensor element of the exhaust gas sensor of FIG. 1.

FIG. 3 is a plan view of an ultrasonic spraying device and support fixture used in applying electrode material to the sensor element of FIG. 2.

FIG. 4 is an enlarged section view taken along line 4-4 of FIG. 3.

FIG. 5 is section view of the sensor element illustrating the application of a conductive lead to the inner surface of the sensor element.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

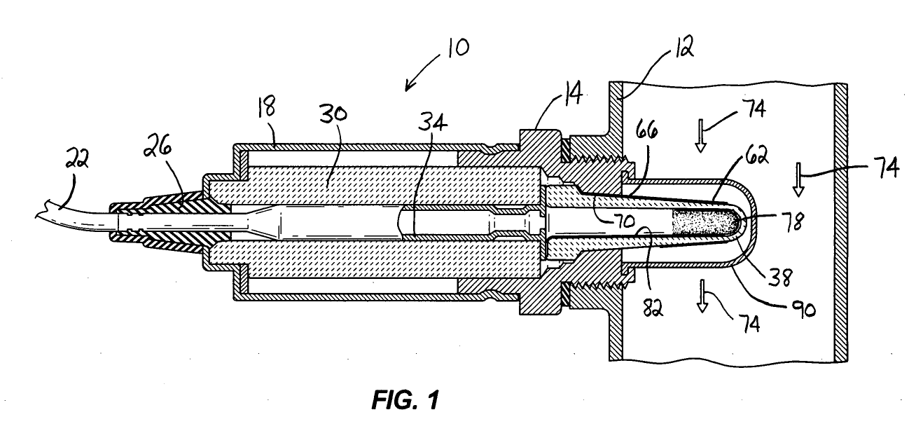

FIG. 1 illustrates an exhaust gas sensor 10 according to the invention. The sensor 10 is shown mounted to an exhaust conduit 12 of an automobile or other vehicle powered by an internal combustion engine. The illustrated sensor 10 is a case-grounded, unheated, single wire sensor, however, those skilled in the art will understand that the sensor 10 could be modified to be a heated, multiple-wire sensor. Except for the method of applying the inner electrode and the resulting applied inner electrode described in detail below, the general construction of the illustrated sensor 10 is described in detail in U.S. Patent Application Publication No. 2004/0074284 published Apr. 22, 2004, and the entire contents of that application are incorporated by reference herein. It is also to be understood that the invention is applicable to other exhaust gas sensor designs that include a cup-shaped or “thimble” type sensor element, as described in detail below. The invention can also be adapted to other applications in which a substantially uniform and well-controlled layer of material is applied to an inner surface of a generally tubular substrate.

The sensor 10 includes a housing 14, a sleeve 18 coupled to the housing 14, and a lead wire 22 exiting the sleeve 18 through a grommet 26. An insulating bushing 30 is housed within the sleeve 18, and includes a bore that houses and electrically isolates a contact pin 34.

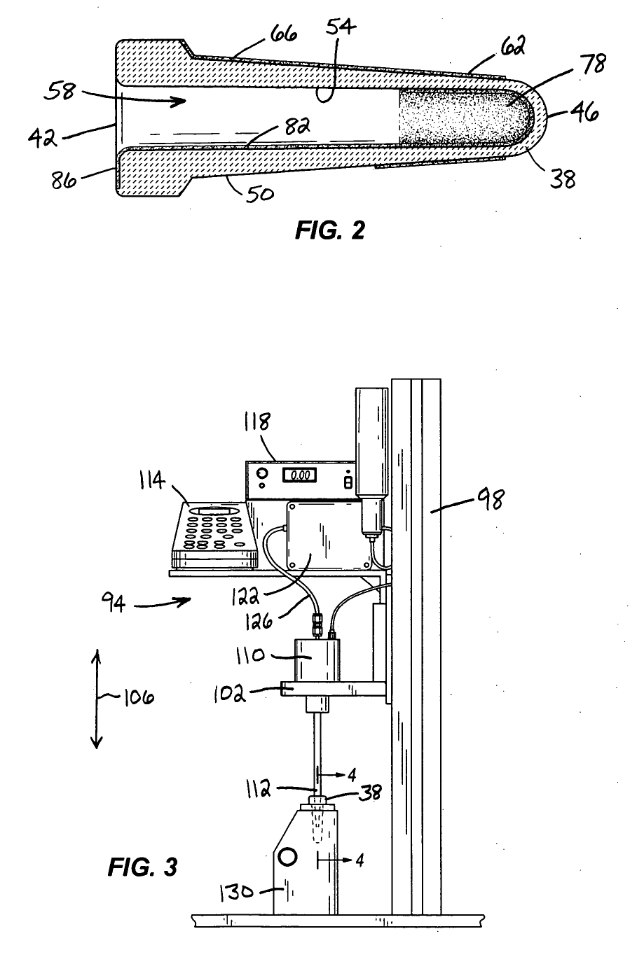

The sensor 10 also includes a ceramic, cup-shaped or thimble-shaped sensor element 38 of the type commonly known and made from materials such as stabilized ZrO₂, CaO— and/or Y₂O₃— stabilized ZrO₂, Al₂O₃, Mg-spinel, and forsterite. The sensor element 38 is retained in the housing 14 and, as shown in FIGS. 2 and 5, includes an open end 42, a closed end 46, an outer surface 50, and an inner surface 54. The inner surface 54 defines a chamber 58 extending between the open end 42 and the closed end 46.

As best seen in FIGS. 1 and 2, an outer or exhaust electrode 62 of conductive and catalytically active electrode material, such as platinum or other similar conductive and catalytically active materials (e.g., Pd and Rh), is positioned on the outer surface 50. A lead portion 66 of the exhaust electrode 62 extends along the outer surface 50 toward the open end 42 of the sensor element 38 to be in electrical contact with a bore 70 of the housing 14, thereby grounding the exhaust electrode 62 through the housing 14. The exhaust electrode 62 communicates with the exhaust gas stream (depicted by the arrows 74 in FIG. 1), as is understood by those skilled in the art.

An inner or reference electrode 78 of conductive and catalytically active electrode material, such as platinum or other similar conductive and catalytically active materials (e.g., Pd and Rh), is positioned on the inner surface 54 of the sensor element 38 within the chamber 58. A lead portion 82 of the reference electrode 78 extends along the inner surface 54 toward the open end 42 of the sensor element 38 and out of the chamber 58 along an end surface 86 (see FIGS. 2 and 5) defining the open end 42 of the sensor element 38. The lead portion 82 is configured to be in electrical contact with the contact pin 34 housed in the sensor bushing 30. The reference electrode 78 communicates with reference air inside the chamber 58, as is also understood by those skilled in the art.

The sensor 10 also includes a tube 90 that substantially surrounds and protects the end of the sensor element 38 extending into the exhaust gas stream 74. The illustrated tube 90 is made of stainless steel or other heat-resistant metal alloys and is secured to the housing 14. The tube 90 allows exhaust gas to enter therein for communication with the sensor element 38, yet protects the sensor element 38 from debris particles contained within the exhaust gas stream 74.

The method of applying the reference electrode 78 to the inner surface 54 of the sensor element 38 will now be described with reference to FIGS. 3-5. FIG. 3 illustrates an ultrasonic spraying device 94 that is used to apply at least a portion of the reference electrode 78 to the inner surface 54 of the sensor element 38. The illustrated ultrasonic spraying device 94 includes a frame or stand 98 that supports a movable carriage 102. The illustrated carriage 102 can translate both vertically (as indicated by the arrows 106 in FIG. 3) and horizontally (into and out of the page in FIG. 3). An ultrasonic nozzle assembly 110 is mounted on the carriage 102 and includes a nozzle or tip 112. An input device 114 enables the user to control movement of the carriage 102 and operation of the nozzle assembly 110.

The nozzle assembly 110 is electrically connected to a broadband ultrasonic generator 118. While any suitable ultrasonic nozzle assembly and ultrasonic generators can be used, the illustrated nozzle assembly 110 and broadband ultrasonic generator 118 are available from Sono-Tek Corporation of Milton, N.Y. as a Model Number 8600-6015 nozzle assembly with a MicroSpray nozzle, and a Part Number 06-05108 broadband (20-120 kHz) ultrasonic generator. The electrode material is stored in paste or slurry form in a storage reservoir 122 and is provided to the nozzle assembly 110 via conduit 126. In the illustrated embodiment, the slurry or paste contains ceramic and metal particles having a diameter of less than about sixty microns suspended in liquid medium (water or solvent based with auxiliary additives, e.g., dispersing agents, binder systems, and the like). In the illustrated embodiment, the solid ceramic and metal particles constitute between about thirty percent and about seventy percent of the total weight of the slurry or paste, and the liquid components constitute the remaining percentage. The slurry or paste used in the illustrated embodiment has a viscosity of between about fifty to about one thousand mPas.

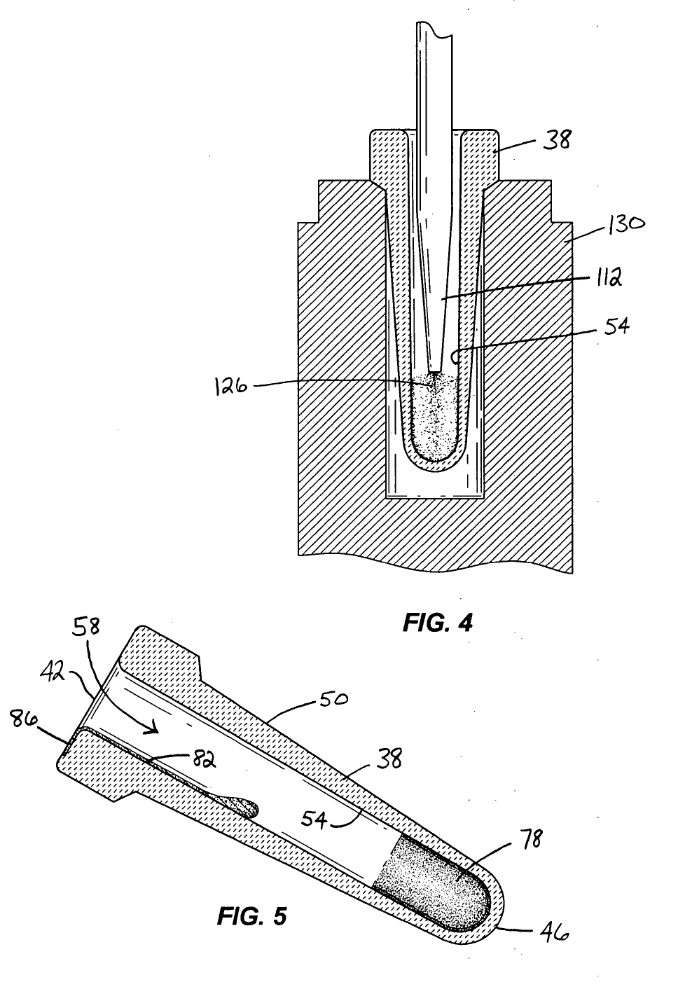

Also shown in FIGS. 3 and 4 is a fixture 130 for supporting one or more sensor elements 38. Those skilled in the art will understand that any suitable fixture can be used to support and retain the sensor elements 38. To apply the electrode material to the inner surface 54 of the sensor element 38, the nozzle 112 is inserted into the chamber 58 of the sensor element 38 as shown in FIG. 4. As the electrode material is provided to the nozzle 112, the broadband ultrasonic generator 118 energizes the nozzle assembly 110 such that the electrode material exiting the nozzle 112 is atomized into a fine mist (as represented by the reference numeral 126 in FIG. 4) that is deposited on the inner surface 54 of the sensor element 38 substantially 360 degrees around the nozzle 112. In other words, the mist 126 travels outwardly from the nozzle 112 in all directions to substantially coat the entire inner surface 54 of the closed end 46 of the sensor element 38 without requiring substantially any relative movement (e.g., rotational or translational) between the nozzle 112 and the sensor element 38 during the application of the atomized electrode material 126. The atomized mist of electrode material 126 provides a substantially uniform and well-controlled layer of electrode material on the inner surface 54.

Using the ultrasonic spraying device 94 to apply at least a portion of the inner electrode 78 substantially reduces the excess usage of expensive electrode material deposited in the chamber 58 of the sensor element 38. In a test of twenty-five sample runs, the average electrode material paste usage using the ultrasonic spraying device 94 was 23.7 mg with an average standard deviation of 1.02. Twenty-five sample runs were also conducted for prior art “fill & extract” and “drip & blow” processes. Using a prior art “fill & extract” process, an average of 36.0 mg of paste was used per run with a standard deviation of 8.0. Using a prior art “drip & blow” process, an average of 60.0 mg of paste was used per run with a standard deviation of 10.0.

The use of the ultrasonic spraying device 94 for the method of the present invention greatly reduces the amount of expensive electrode material needed to apply the portion of the inner electrode 78 adjacent the closed end 46 of the sensor element 38. In addition, the inner electrode 78 can be accurately sized and positioned, and the thickness of electrode material can be accurately controlled. Furthermore, the deposited atomized mist 126 results in good electrode homogeneity, and the ultrasonic vibration also maintains a well-dispersed suspension of the paste or slurry prior to application. There is also no air pressure required for application of the inner electrode 78. This eliminates problems occurring in prior art processes associated with excessive over-spray due to the use of air pressure.

In addition, the method of the present invention eliminates the need for substantially any relative movement (e.g., rotational or translational) between the sensor element 38 and the nozzle 112 during application of the electrode material 126 because the atomized mist of electrode material 126 spreads outwardly, 360 degrees around the nozzle 112. This is in contrast to prior art methods that apply the inner electrode in a ring form by brushing or spraying paste from a nozzle that is rotating and/or translating relative to the sensor element. In twenty-five sample runs conducted using a prior art “ring electrode” process, an average of 35.4 mg of paste was used per run with a standard deviation of 2.90. Therefore, the method of the present invention uses less electrode material than prior art “ring electrode” processes, and also eliminates the need for any mechanically-complex relative rotation and/or translation between the nozzle 112 and the sensor element 38 during application of the electrode material.

It is to be understood that devices utilizing technology other than ultrasound technology, and that can create an atomized mist of electrode material 126 capable of being deposited to form the inner electrode 78 in the manner discussed above, can also be substituted for the ultrasonic spraying device 94. This includes technology currently in existence as well as technology yet to be developed. For example, a spraying device utilizing air pressure to create the atomized mist of electrode material 126 could be used to form the inner electrode 78 without requiring relative movement, or at least without requiring relative rotation, between the air pressure spraying nozzle and the sensor element 38 during application. In another example, a mechanical vibration nozzle could be used to create the atomized mist of electrode material 126 without requiring relative rotation between the mechanical vibration nozzle and the sensor element 38 during application.

Once the portion of the inner electrode 78 is applied using the ultrasonic spraying device 94, the nozzle 112 is removed from the chamber 58. Next, the lead portion 82 of the inner electrode 78 is formed by dripping some of the electrode material down the inner surface 54 of the sensor element 38 as illustrated in FIG. 5. This procedure can occur while the sensor element 38 remains in the fixture 130, or as shown in FIG. 5, can occur after the sensor element 38 has been removed from the fixture 130. As discussed above, the lead portion 82 provides an electrical connection with the remaining portion of the inner electrode 78 that was applied by the ultrasonic spraying device 94.

Once the inner electrode 78 and lead portion 82 have been applied, the outer electrode 62 and lead portion 66 can be applied to the outer surface 50 using any suitable technique. Next, the sensor element 38 is sintered at between about 500 degrees C. and about 1,500 degrees C. to bond the electrode material to the ceramic substrate of the sensor element, thereby forming cermet-type inner and outer electrodes, 78 and 62, respectively. The resulting electrodes 78, 62 have large amounts of three-phase boundaries and are therefore highly active and resistant to contamination. The metal-to-ceramic oxide weight ratio in the sintered cermet electrodes 78, 62 can range from about 10:1 to about 3:2. The layer thickness of the cermet electrodes 78, 62 can range from about two to about thirty microns. After sintering, the sensor element 38 is ready for installation into the exhaust gas sensor 10.

Various features and advantages of the invention are set forth in the following claims.

1. A method of manufacturing an exhaust gas sensor, the method comprising:
providing a sensor element having an open end, a closed end, and an inner surface defining a chamber between the open and closed ends; and
atomizing an electrode material using an ultrasonic spraying device to deposit a layer of electrode material onto the inner surface of the sensor element.

2. The method of claim 1, wherein the ultrasonic spraying device includes a nozzle, and wherein the method further includes inserting the nozzle into the chamber.

3. The method of claim 2, further comprising supplying the electrode material to the nozzle as one of a paste and a slurry.

4. The method of claim 1, wherein the layer of electrode material is deposited substantially 360 degrees around the inner surface of the sensor element without substantially any relative rotation between the sensor element and the ultrasonic spraying device.

5. The method of claim 1, wherein the deposited layer of electrode material defines an inner electrode, and wherein the method further comprises forming a conductive lead on the inner surface, in electrical contact with the inner electrode, and extending toward the open end of the sensor element.

6. The method of claim 5, wherein forming the conductive lead includes dripping electrode material along the inner surface of the sensor element and into contact with the inner electrode.

7. The method of claim 1, further comprising sintering the sensor element.

8. The method of claim 7, wherein providing the sensor element includes providing a sensor element of a ceramic material, and wherein sintering the sensor element bonds the electrode material to the ceramic sensor element to form a cermet-type inner electrode.

9. The method of claim 1, wherein the sensor element further includes an outer surface, the method further comprising applying an outer electrode to the outer surface of the sensor element.

10. A method of manufacturing an exhaust gas sensor, the method comprising:
providing a sensor element having an open end, a closed end, and an inner surface defining a chamber between the open and closed ends;
inserting a nozzle into the chamber;
supplying an electrode material to the nozzle; and
without substantially any relative rotation between the nozzle and the sensor element, atomizing the electrode material to deposit a layer of electrode material onto the inner surface of the sensor element substantially 360 degrees around the nozzle.

11. The method of claim 10, wherein the nozzle is part of an ultrasonic spraying device.

12. The method of claim 10, wherein supplying the electrode material to the nozzle includes supplying one of a paste and a slurry of electrode material to the nozzle.

13. The method of claim 10, wherein atomizing the electrode material creates a mist of the electrode material that substantially surrounds a tip of the nozzle.

14. The method of claim 10, wherein the deposited layer of electrode material defines an inner electrode, and wherein the method further comprises forming a conductive lead on the inner surface, in electrical contact with the inner electrode, and extending toward the open end of the sensor element.

15. The method of claim 14, wherein forming the conductive lead includes dripping electrode material along the inner surface of the sensor element and into contact with the inner electrode.

16. The method of claim 10, further comprising sintering the sensor element.

17. The method of claim 16, wherein providing the sensor element includes providing a sensor element of a ceramic material, and wherein sintering the sensor element bonds the electrode material to the ceramic sensor element to form a cermet-type inner electrode.

18. A method of manufacturing an exhaust gas sensor, the method comprising:
providing a ceramic sensor element having an open end, a closed end, and an inner surface defining a chamber between the open and closed ends;
inserting a nozzle into the chamber;
supplying an electrode material to the nozzle; and
without substantially any relative movement between the nozzle and the sensor element, atomizing the electrode material to form a mist of electrode material that substantially surrounds the tip of the nozzle and deposits onto the inner surface of the sensor element to form an inner electrode.

19. The method of claim 18, wherein the nozzle is part of an ultrasonic spraying device.

20. The method of claim 18, wherein supplying the electrode material to the nozzle includes supplying one of a paste and a slurry of electrode material to the nozzle.

21. The method of claim 18, wherein the atomized mist of electrode material is deposited onto the inner surface of the sensor element substantially 360 degrees around the nozzle.

22. The method of claim 18, wherein the deposited layer of electrode material defines an inner electrode, and wherein the method further comprises forming a conductive lead on the inner surface, in electrical contact with the inner electrode, and extending toward the open end of the sensor element.

23. The method of claim 22, wherein forming the conductive lead includes dripping electrode material along the inner surface of the sensor element and into contact with the inner electrode.

24. The method of claim 18, further comprising sintering the sensor element.

25. The method of claim 24, wherein providing the sensor element includes providing a sensor element of a ceramic material, and wherein sintering the sensor element bonds the electrode material to the ceramic sensor element to form a cermet-type inner electrode.
